(19) United States
(12) Patent Application Publication
(10) Pub. No.: US 2016/0243850 A1
(43) Pub. Date: Aug. 25, 2016

(54) METHOD AND SYSTEM FOR MARKING FOOD PRODUCTS WITH SOURCE VERIFICATION INFORMATION, AND COLLECTION AND DISSEMINATION OF SUCH SOURCE VERIFICATION INFORMATION

(71) Applicant: TEN Media, LLC dba TEN Ag Tech Co., San Juan Capistrano, CA (US)

(72) Inventors: Jonathan R. Phillips, San Juan Capistrano, CA (US); Scott D. Smith, Laguna Niguel, CA (US); Richard C. Blackburn, Santa Ana, CA (US)

(73) Assignee: TEN Media, LLC dba TEN Ag Tech Co., San Juan Capistrano, CA (US)

(21) Appl. No.: 15/006,107

(22) Filed: Jan. 25, 2016

Related U.S. Application Data
(60) Provisional application No. 62/107,398, filed on Jan. 24, 2015.
(60) Provisional application No. 62/107,513, filed on Jan. 26, 2015.

(51) Int. Cl. B41J 3/407

(52) U.S. Cl. CPC B41J 3/4073; B41J 2/455

(57) ABSTRACT

The present disclosure includes a method and system for applying markings on a food product in such a manner to form a permanent marking thereon. The markings may include text, graphics, images, other types of indicia, and any combination thereof. In a preferred embodiment, the markings include freshness information, traceability data, historical processing information, other types of relevant source information, or any combination thereof. The markings are applied by any suitable marking device known in the art, such as laser-based or ink-based technologies. The source information is stored in memory, such as cloud-based memory, for later use, such as production planning, product recalls, other commercial and regulatory purposes, and the like.

### CROSS-REFERENCE TO RELATED APPLICATIONS

This application claims the benefit of U.S. Provisional Application No. 62/107,398 filed on Jan. 24, 2015 and U.S. Provisional Application No. 62/107,513 filed on Jan. 26, 2015, the contents of which are incorporated herein by reference in their entirety.

### BACKGROUND

The disclosure relates generally to the field of food product processing, and more particularly methods and systems for marking source verification information and other relevant data on food products and associated packaging. The disclosure further relates to methods and systems for monitoring and managing food product processing facilities. While reference is made herein to eggs in particular, it should be understood that this disclosure is directed to all food products in which images and/or data may be applied thereon.

In the egg packing industry, eggs typically undergo a great deal of processing before they are ready to be sold to the consuming public. In many circumstances, for example, eggs pass through several processing stations where they are washed, candled, weighed, graded, and packed into packages (e.g., cartons, crates, or other commercially distributed containers). Examples of such processing stations and mechanisms for conveying eggs from station to station are described, for instance, in the following U.S. patents assigned to Diamond Automations, Inc. (U.S. Pat. Nos. 4,189,898; 4,195,736; 4,505,373; 4,519,494; 4,519,505; 4,569,444; 4,750,316; 5,321,491; and 6,056,341) and TEN Media LLC (U.S. Pat. No. 8,455,030), which are incorporated herein by reference in their entirety. As a reference, it is not uncommon for a facility in which these stations operate to output about one million eggs in a single day. Accordingly, to be commercially acceptable, the throughput of the stations needs to be quite high, with some stations typically processing on the order of 20,000 eggs per hour.

The egg packing industry uses devices known as “packers” to pack the eggs into the packages. Typically, a packer includes a conveyor (e.g., a belt conveyor, roller conveyor, chain conveyor, etc.) that moves empty packages through an egg loading section (where the eggs are loaded into the egg loading section from above) and then moves the filled packages to a package closing section that is responsible for closing the lids of the packages. The eggs may be supplied to the egg packer via a grader system.

An egg packing process that uses “packers,” typically uses bulk belts to bring eggs from a bulk supply location. The eggs are cleaned or disinfected, in some instances using UV light while clamped to transport chains, and in some instances through immersion in sanitizing wash water. The eggs are then inspected either electronically or manually, they are weighed to establish size, inspected for cracks using ultrasonic inspection and loaded into a chain driven carriage mechanism (“Transfer Loader”). The egg is then, normally transported to one of a plurality of packing machines by the aforementioned carriage mechanism. The particular packing machine to which any individual egg may be transported is determined by a computer. This process or elements thereof up to, but not including the packing machine, constitute grading (“Grading” and the “Grader”). The carriage mechanism typically consists of one or a plurality of chains, running the length of the Grader past all the packing machines in the horizontal plane (“Grader Chains”). The packing machines are usually configured with an egg flow perpendicular to the Grader Chain in the horizontal plane.

The egg industry uses marking devices to print Size, Grade and Date information together with other information or images and logos (“Data”) on to the surface of an egg shell of a fresh egg travelling through an egg grading machine. The marking devices are traditionally placed in a location on the production line that is responsible for grading the eggs and the site for such installation is chosen to minimize the number of marking devices required for a given installation. Marking devices have typically been installed on the Grader Chains as near to the Transfer Loader as practical, and typically (although not always), prior to all the packing machines to which almost all eggs are later diverted.

Because shell eggs are a perishable item susceptible to spoilage, egg packages typically have expiration (or sell-by) dates marked on them. Thus, certain governmental bodies, e.g., the United States Food and Drug Administration (FDA), the United States Department of Agriculture (USDA), and various state governments, generally require that shell egg cartons have printed on the carton a sell-by date, a packaging date (printed as a Julian date, i.e., a three-digit day number relative to the day of the year in which the eggs were packaged), and a plant code. The grade and size of the eggs may also be printed on the carton. Many consumers, however, move eggs from their packages into special receptacles in their refrigerators. When this is done, the consumer is no longer able to evaluate the sell-by dates of individual eggs prior to using them.

Furthermore, certain governmental bodies, e.g., the United States Food and Drug Administration (FDA), the United States Department of Agriculture (USDA), and various state governments, currently do not allow retailers to “repack” eggs, i.e., to move eggs from one package to another after the eggs have left the egg processing facility. This restriction can result in tremendous waste because whenever the integrity of even a single egg in a package in the hands of a retailer is compromised (e.g., is broken), the entire package of eggs must be discarded.

Several techniques for marking individual shell eggs with sell-by dates and the like have been proposed. One such approach is to use vegetable dyes or other water-soluble ink products to mark the eggs. Such products, however, have a tendency to migrate through the shell into the interior of eggs and can result in undesirable ink spots within them. The tendency of such products to wash off or fade also means that such markings are susceptible to tampering and even unintentional loss of integrity (e.g., dripping and smearing from condensation and handling), and has generally limited their acceptance.

It is also known to use lasers to mark indicia onto perishable products for the purpose of tracking their pedigree and/or integrity (e.g., using date codes and/or traceability codes), as well as for allowing textual or graphical advertising messages to be disseminated via such products. An example of a system for laser marking such information on hen eggs is described, for example, in U.S. Pat. No. 8,084,712 (“the '712 Patent”) issued Dec. 27, 2011 and assigned to TEN Media, LLC. The disclosure of the '712 Patent is incorporated herein by reference in its entirety.

The approach described in the '712 Patent is to laser mark information on eggs as they are conveyed at high speed during the grading process. Although this approach has proven effective for certain applications, the extremely high throughput of the grading machines, the lack of uniformity in the moisture content of the surface of individual eggs during the grading process, and the significant amount of dust created during the laser marking process, among other things, have made it challenging to mark individual eggs with sufficient accuracy, reliability, and consistency for certain purposes. Examples of systems and methods for improved laser marking of shell eggs are described, for instance, in the following U.S. patents assigned to TEN Media, LLC: U.S. Pat. Nos. 8,499,718; 8,455,026; 8,657,098; 8,455,030; 8,823,758; and 8,715,767, the entire contents of each of which are incorporated herein by reference.

Shell egg grading and packaging facilities are required to comply with a number of regulatory and customer requirements to ensure the safe production and packaging of shell eggs. These facilities include in-line processing facilities, where egg processing occurs at the same location as the egg production facility. This processing method is generally the most efficient egg collection and processing method of eggs available because eggs are delivered from the egg production facility directly to the egg processing facility by an enclosed and temperature controlled conveyor system. In off-line processing, the egg processing occurs separately from the egg production facility, which may be referred to as satellite farms. Satellite farms are egg production facilities that are located at a different location from the egg processing facility, and eggs produced at satellite farms must be gathered and delivered to the egg processing facility. These shell eggs may also be referred to as “nest run” eggs, which are eggs that arrive from a facility other than the egg processing facility.

In general, because a production facility may receive eggs from various sources, there is always a possibility of cross-contamination. Thus, there is a need for information related to the source of the eggs to be processed through a common data collector and then consolidated and stored at a central location remote from the facilities. This central location should be accessible (after authentication and encryption) by all interested parties that have a need for such information for commercial and regulatory purposes, specifically, egg-source-specific product recalls.

There is a need for additional information related to grading and processing eggs in addition to the information typically placed on eggs and egg cartons, as well as other food products. This additional information may be utilized for production planning, product recall, and other commercial and consumer purposes, should be compact and error-free while imparting the necessary information for easy marking of eggs and its packaging, and should also be available for remote lookup and analysis of the data by interested parties.

### BRIEF SUMMARY

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with embodiments herein, the present disclosure includes a method and system for applying markings on a food product in such a manner to form a permanent marking thereon. The markings may include text, graphics, images, other types of indicia, and any combination thereof. In a preferred embodiment, the markings include freshness information, traceability data, historical processing information, other types of relevant source information, or any combination thereof. The markings are applied by any suitable marking device known in the art, such as laser-based or ink-based technologies. Desirably, the marking is applied so as to leave much of the area of the food product unaffected so as to form contrast between the unaffected areas and the marking. The method preferably forms the markings on the food product while the product moves through a predetermined region of a food processing system. The performance or characteristics of the marking device may be adjusted in response to selected characteristics of the food product in order to optimize the marking applied thereon.

In a preferred embodiment, the present disclosure includes a method and system for applying markings on a food product by applying a radiant energy to the food product in such a manner to form a permanent marking thereon. A laser is preferably employed as the radiant energy source. Desirably, the radiant energy is applied so as to leave much of the area of the food product unaffected so as to form contrast between the unaffected areas and the marking. The method preferably forms the markings on the food product while the product moves through a predetermined region of a food processing system. The performance or characteristics of the laser may be adjusted in response to selected characteristics of the food product in order to optimize the marking applied thereon.

In a preferred embodiment, the present disclosure includes a method and system for applying markings on an egg by applying a radiant energy source to the shell of the egg so as to cause discoloration of the egg shell to form a permanent marking. In a preferred embodiment, the markings are made by laser etching without applying a foreign material to the egg shell.

In accordance with embodiments herein, the present disclosure includes an apparatus for applying markings on food products that is operable in association with a food packing system that packages the food products. The apparatus comprises a marking device located in proximity to the food packing system so that the marking device can form markings thereon.

A preferred embodiment includes an apparatus for applying markings on eggs that is operable in association with an egg-handling machine that performs washing, candling, grading, and packing of eggs. The apparatus comprises a marking device located in proximity to the egg-handling machine, so that the marking device can form the markings. In a preferred embodiment, the egg has a marking applied thereon, wherein the marking is formed at least in part by discolored material on the egg shell. The egg may include the marking being formed entirely by discolored material of the egg shell. The egg may also be raw or pasteurized. The markings may be formed by a generally stationary marking device as the egg is transported past the marking device.

In some embodiments, the present disclosure provides a method and system for applying markings on food products, comprising conveying the food product to a marking station having at least one laser marking device configured to apply laser energy of sufficient intensity to etch indicia on the food product, and activating the laser device to apply laser energy to the food product and etch the indicia thereon. The markings may include text, graphics, images, other types of indicia, and any combination thereof. In a preferred embodiment, the markings include freshness information, traceability data, historical processing information, other types of relevant source information, or any combination thereof. In a preferred embodiment, the food product is an egg, and the laser etches the indicia on the outer surface of the shell of the egg. The applied laser energy may ablate and/or discolor the surface of the egg shell to an approximate depth that is within the range of about 5 to about 25 micrometers. The applied laser energy may ablate and/or discolor the surface of the egg shell to an approximate depth that is within the range of about 1.5 to about 8 percent of the thickness of the egg shell.

In accordance with embodiments herein, the markings applied to the food products, food packaging, and combinations thereof include source information data, such as traceability data that provide food traceability capabilities which allow consumers, retailers, food processing facilities, food product providers, and other interested parties to track and/or access historical data associated with processing for such food product. The historical data may include, but is not limited to, food source location details, food processing facility details, food processing environmental and processing conditions, food product characteristics, food product distribution details, regulatory compliance details, other relevant information, and any combination thereof. The traceability data may be generated and/or encoded using any suitable characters set. In a preferred embodiment, the traceability data is encoded using alphanumeric character sets. In a preferred embodiment, the traceability data may be stored in an associated memory for later use, such as production planning, product recalls, other commercial and regulatory purposes, and the like.

In a preferred embodiment, the present disclosure provides methods and systems for collecting, consolidating, and analyzing source information from multiple sources. Source information may be collected from information marked on multiple food products, multiple processing runs on a device or system, multiple marking devices or systems within a processing facility, multiple processing facilities, multiple distribution systems, and the like, or any combination thereof. The collected information is then consolidated and stored in memory for later use by authorized users. The consolidated data may be stored locally and/or remotely by any suitable means. In a preferred embodiment, the present disclosure provides a cloud-based system for collecting, consolidating, and disseminating the source information. The source information contained therein may be analyzed with respect to food source location details, food processing facility details, food processing environmental and processing conditions, food product characteristics, food product distribution details, regulatory compliance details, and the like.

Still other advantages, aspects and features of the subject disclosure will become readily apparent to those skilled in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious aspects all without departing from the scope herein. Accordingly, the drawings and descriptions will be regarded as illustrative in nature and not as restrictive.

### BRIEF DESCRIPTION OF THE DRAWINGS

The accompanying drawings incorporated herein and forming a part of the specification illustrate the example embodiments.

FIG. 1 is a diagram depicting an egg bearing markings using method and apparatus embodiments of the present disclosure.

FIG. 2 is a diagram of another view of an egg bearing markings using method and apparatus embodiments of the present disclosure.

FIG. 3 is a diagram of another view of an egg bearing markings using method and apparatus embodiments of the present disclosure.

FIG. 4 is a diagram of a top view of an egg bearing markings using method and apparatus embodiments of the present disclosure.

FIG. 5 is a block diagram depicting portions of an egg-handling machine and particularly illustrating inline and offline operations.

FIG. 6 is a diagrammatic view depicting an apparatus for performing an embodiment of the method of the present disclosure.

FIG. 7 is a diagrammatic view depicting an apparatus for performing an embodiment of the method of the present disclosure.

FIG. 8 is a diagrammatic view depicting a laser printing assembly for performing an embodiment of the method of the present disclosure.

FIG. 9 illustrates an example of a computer system 900 upon which an example embodiment may be implemented.

FIG. 10 is a schematic diagram illustrating an example embodiment of traceability data according to the present disclosure.

FIG. 11 is a schematic diagram illustrating an example embodiment of traceability data according to the present disclosure.

FIG. 12 is an example flow diagram of marking on eggs with the apparatus as shown in FIGS. 6 and 7 in accordance with an example implementation.

FIG. 13 is an example flow diagram of marking on eggs with the apparatus as shown in FIGS. 6 and 7 in accordance with an example implementation.

FIG. 14 is a diagram depicting an egg bearing markings using method and apparatus embodiments of the present disclosure.

FIG. 15 is a block diagram illustrating an example embodiment of a cloud-based network for remote storage of source information according to the present disclosure.

FIG. 16 is a schematic diagram illustrating a data entry in a relational storage component for storing source information according to the present invention.

### DETAILED DESCRIPTION OF THE PREFERRED EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In general, the embodiments herein provide methods and systems for marking source information and other relevant data on food products and associated packaging. Embodiments of the present disclosure are directed to an apparatus as well as a method for marking food products as they pass through a marking station, with the marking being carried out by marking devices that are designed and configured to render text and graphic representations as the food products pass through the marking station. While reference is made herein to eggs in particular, it should be understood that this disclosure is directed to all food products in which a mark may be applied thereon. In the example embodiment, there is provided a method and system for applying markings on an egg by a marking device so as to cause discoloration of the egg shell to form a permanent marking. However, it is to be appreciated that the embodiments of the claims herein are not limited in any way to the example embodiment, but rather are to be interpreted to cover applying markings to other suitable food products. That is, the embodiments herein can be applied to any suitable food product.

It is further understood that the preferred embodiment for applying a marking on eggs is by applying a radiant energy source to the shell of the egg so as to cause discoloration of the egg shell to form a permanent marking thereon. However, it is to be appreciated that the embodiments contained herein are not limited to the preferred embodiments, but rather are to be interpreted to cover applying markings by any suitable marking device.

It should be understood that the terms “marking” or “etching” as used herein are intended to mean that a laser is employed as a radiant energy source. The laser beam is applied to leave most of the egg shell unaffected so as to provide contrast between the unaffected areas and the marking. The laser beam ablates and/or discolors the outer surface material from the egg shell. A significant benefit of the use of laser marking is that brown eggs have etched indicia that is a contrasting white color, while white eggs have etched indicia that is a contrasting dark brown color. The structural integrity of the egg shell is not affected because the etching by the beam only affects the outer approximately 5 to approximately 25 micrometers of the egg shell, which is approximately 1.5% to approximately 8% of the thickness of the egg shell.

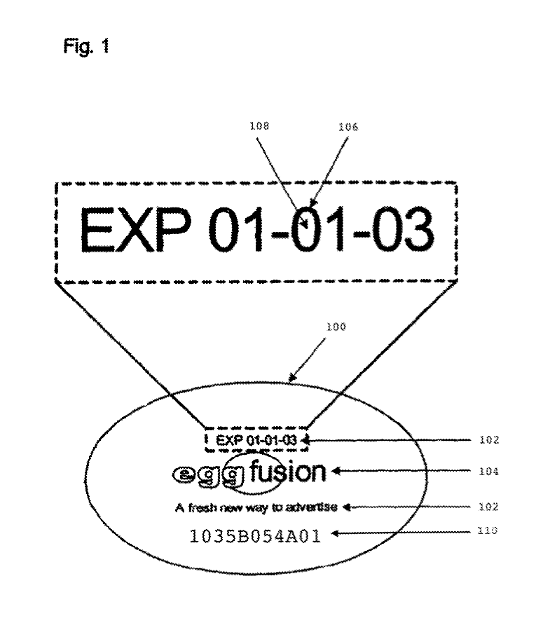

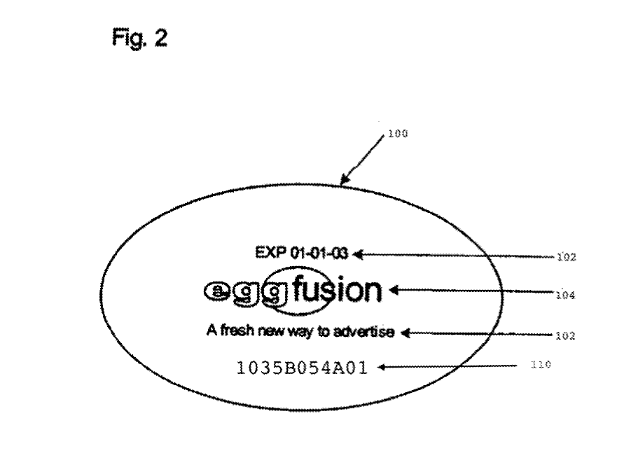

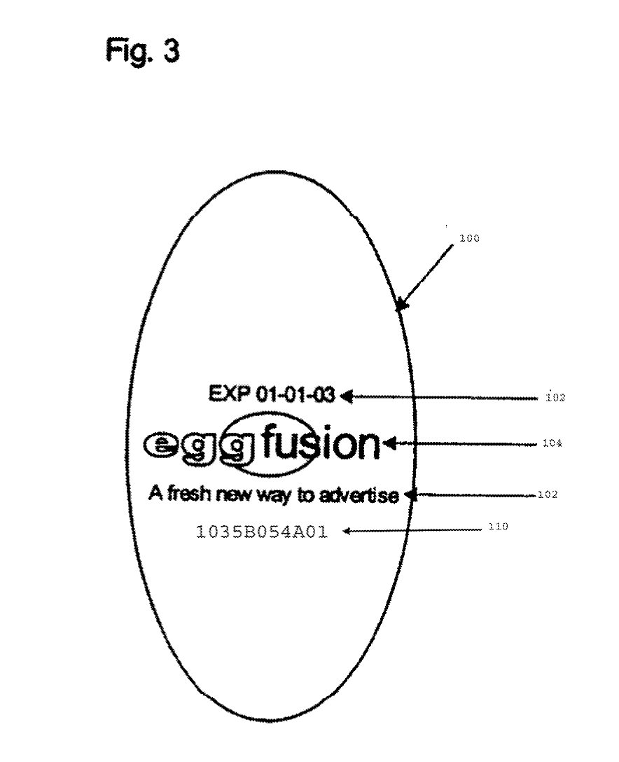

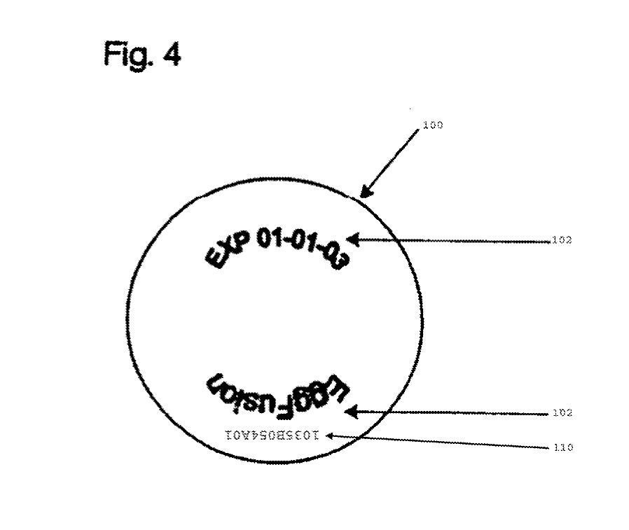

Referring to FIG. 1, an egg 100 is provided with markings or indicia, The markings include text 102 and graphics 104, and can include freshness information, traceability data, historical processing information, advertising, sponsored images, promotional information, or other types of relevant information, or any combination thereof. The markings are formed by discoloring material of the shell to form text 102 and graphics 104, such as that which forms the number 0 as indicated at 106, and leaving other areas of the shell unaffected, such as the area inside the number 0, as indicated at 108. The discoloration may also be done variably so as to form a gradient of discoloration to form the graphics 104, or to create a variety of text 102, such as bold text, italic text, or any type of text or font. That is, some areas may be more discolored than others as, for example, by exposing them to radiant energy for a higher intensity or longer duration (i.e., multiple passes of the radiant energy thereover) than other areas. An example of traceability data is shown as 110. The text and graphics may be applied horizontally (FIG. 2), vertically (FIG. 3), or on top (FIG. 4) of the egg.

Radiant energy as, for example, electromagnetic radiation such as visible, infrared, or ultraviolet light, can be used to discolor the egg shell. The radiant energy can be controlled to only discolor a targeted print area 106 of the egg shell. Some areas of the egg can be left unaffected 108 (see FIG. 1). The discoloration of the egg shell is easily viewable because of the contrast of the egg shell color 108 to the discoloration 106 from the radiant energy. A significant benefit of the use of laser marking is that brown eggs have etched indicia that is a contrasting white color, while white eggs have etched indicia that is a contrasting dark brown color. The discoloration can be used to form indicia or marking information on the eggs. The discoloration to form text and graphics can be applied generally simultaneously by one or more radiant energy sources.

In the preferred embodiment in which a radiant energy source is used, no foreign material is required to be added to the egg shell in order for the radiant energy to discolor the egg shell. Thus, no foreign material, such as ink or radiant energy sensitive material that could react with the radiant energy needs to be added to form a marking. The radiant energy is applied to the natural eggshell. Thus, the marking most desirably is formed solely by the effect of the radiant energy on the normally occurring materials of the eggshell itself. This provides several significant benefits. The egg can be properly represented to the consumer as a product with no additives or contaminants. Moreover, because it is not necessary to apply additional materials for purposes of the marking process, it is unnecessary to add the equipment needed to coat the egg with a foreign substance. This greatly simplifies the task of performing the process inline in the production environment of an existing high-speed egg handling apparatus. Additionally, the potentially significant cost of such additional materials is avoided.

In a method according to a preferred embodiment of the present disclosure, a radiant energy source in proximity of an egg directs radiant energy towards the egg. Radiant energy source desirably includes a laser such as a CO2 gas laser adapted to provide light wavelengths of about 9.0 to 10.7 microns, at a minimum of 25 watts, and a projected maximum of 200 watts radiated power, in a beam projected from approximately 100 mm at the surface of the egg. When operated in this power range, the beam ablates and/or discolors the outer surface material from the egg shell. The structural integrity of the egg shell is not affected because the etching by the beam only affects the outer approximately 5 to approximately 25 micrometers of the egg shell, which is approximately 1.5% to approximately 8% of the thickness of the egg shell. The beam is directed onto those areas of the egg, which are to be discolored and turned on and off so as to provide a series of pulses, the beam being “on” for up to about 60 milliseconds during each pulse. During this pulsed actuation, the beam is swept across those areas of the egg surface, which are to be discolored. The sweeping motion may be performed in any manner which will provide the desired relative motion of the beam and the egg. Since the preferred embodiments will operate in association with an egg-handling machine which moves eggs at an extremely rapid speed, the beam must be rapidly moved to produce the desired indicia and also may compensate for the speed of movement of the eggs past the laser apparatus, which is preferably stationary. For example, the radiant energy source may include a beam-sweeping unit incorporating conventional optical elements such as movable or variable lenses, mirrors or prisms adapted to deflect the beam and to vary the deflection with time. Suitable radiant energy sources include, but are not limited to, Sealed CO₂ Gas Lasers, Slow-flow CO₂ Gas Lasers, TEA CO₂ Mask Lasers, CO₂ Gas Lasers, UV Gas Lasers, solid-state visible light lasers, and Mid-IR Solid State Lasers. In other embodiments, the radiant energy source may be also be a YAG-type and/or fiber laser system, and may be coupled with a frequency multiplying optical element.

In another embodiment, an ink-based marking device is placed in proximity of an egg and directs ink toward the egg. Suitable ink-based marking systems include non-contact systems that do not direct contact of the printing system with the egg surface, such as CIJ printing system discussed above. Such system may be mounted so as to mark while the eggs are contained by the calipers on the Grader Chains of an egg grading machine. The system may also be mounted on the Packer and traverse across each row of eggs, applying markings thereon. The CIJ printing system could include a single-jet CIJ printer, a dual-jet CIJ printer, or a Binary Array type of CIJ printer, or a drop-on-demand printer system using technologies including Thermal Inkjet (TIJ), Piezo-electric Inkjet, and MEMS-based Inkjet.

Drop-on-Demand technology can offer significantly higher resolution printing than CIJ technologies, thereby offering good potential for creating high-quality desirable sponsored images. Additionally, Drop-on-Demand technology configurations may use ink cartridges (as opposed to a large reservoir and associated pumps, valves, etc.), which can reduce equipment maintenance requirements. Drop-on-Demand technology options may be mounted above the eggs at a Grader processing step before the Grader Transfer, where the eggs travel at a lower speed and the higher resolution print can be better controlled.

Another example of an ink-based marking system is one that is mounted on the packer and uses to six independent ink sources, each arranged above one egg in a row of eggs (each row has up to 6 eggs). As the eggs pass under the ink source in their typical (as though unmarked) path through the packing machinery, ink is sprayed onto the surface of the egg. Such ink source could include the same technology options as discussed above.

Drop-on-demand technology could also be used in a grader-based application, especially when marking at a step in the process prior to the Grader Transfer (on the grader chains, the eggs move faster and the possible resolution of printing is reduced).

In a method according to an embodiment of the present disclosure, an egg moves through a portion of an egg-grading machine. An egg-grading machine grades the quality of the eggs, and may also transport the eggs towards a packaging machine. Egg-grading machines will move the egg along a path. Somewhere along the path, and preferably immediately before the eggs are packed, a predetermined region can be selected where the egg will pass through and radiant energy can form markings on the egg. Typically, egg-grading machines have calipers that hold the eggs at some point in the path of the egg-grading machine. The marking device may be placed in proximity to this point when the eggs are held so that the marking device forms the markings on an egg as it passes through this predetermined region. This eliminates any need for a special apparatus to position the egg. In this way the method is performed inline with the egg-grading machine.

In another embodiment of the present disclosure, a marking device may be placed in proximity of an existing egg-handling machine. Egg-handling machines includes any device or apparatus that will control the movement of an egg along a path, including egg-grading machines. The marking device can be placed in proximity to the egg-handling machine so that the markings may be applied to the egg inline. The egg-handling machine moves an egg along a conveyor apparatus in a particular direction. A marking device is placed in proximity to the conveyor apparatus such that marking device is directed towards egg.

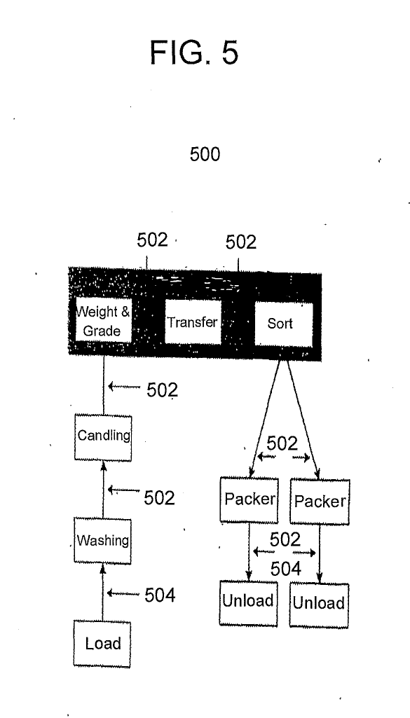

There are many variations of egg-handling machines. Most perform some common minimal basic functions. FIG. 5 is a block diagram outlining the basic functions of those machines. The eggs move through these machines 500 while these basic functions are performed, and a radiant energy source can be placed inline 502 or offline 504 in between many of these functions to perform a method of the present disclosure. The eggs are loaded into the machine. An offline procedure may be performed after this function. The eggs are then washed, after which an inline method may be performed. The eggs are candled, after which an inline method may be performed. The eggs move to the grading portion of the machine where they are weighted and graded, after which an inline method may be performed. The eggs are then transferred to a sorter, before which an inline method may be performed. The eggs are then sorted by grades and sizes, after which an inline method may be performed. The eggs are placed into a package, after which an inline method may be performed. An offline process 504 can be performed prior to the load processor and, typically involves human intervention or some other form of mechanical intervention alien to the egg-handling machine. In preferred embodiments of the present disclosure, the marking device can be associated with an existing egg-handling machine without appreciably modifying the machine. The egg-handling machine preferably includes sensors or other suitable monitoring devices for monitoring the operational and environmental parameters of the egg-handling machine.

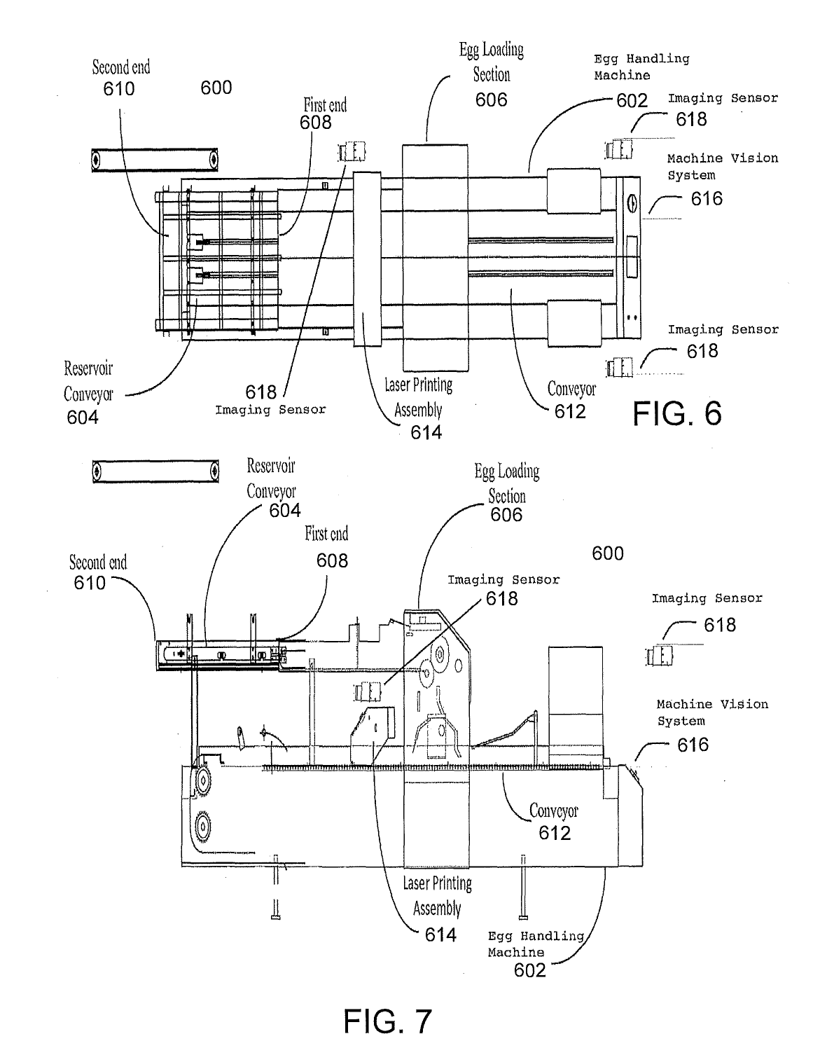

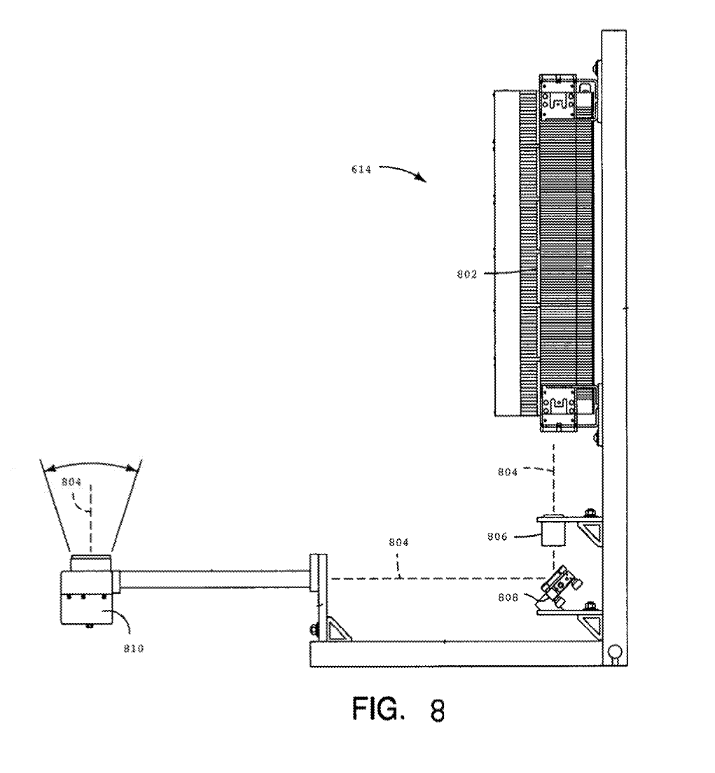

FIG. 6 illustrates a top-view of a system diagram of an example embodiment of an apparatus 600 that is operable in association with an egg-handling machine 602 that performs washing, candling, grading, and packing of eggs as discussed above. The apparatus includes at least one laser printing assembly 614 comprised of at least one laser source operable to apply laser markings on eggs. FIG. 7 illustrates a side view of the system diagram of an example embodiment of apparatus 600 that is operable in association with egg-handling machine 602. While reference is made herein to eggs in particular, it should be understood that the same principles and features may be applied to an apparatus for applying marks on other suitable food products. Further, while reference is made to a laser printing assembly comprised of at least one laser source, it should be understood that any suitable marking device may be used, such as an ink-based printing assembly comprised of at least one ink-based printing head.

A reservoir conveyor 604 is connected to an egg loading section 606 of the egg handling machine 602 at first end 608 and an egg grading machine (not shown) at second end 610. In an example operation, eggs are passed from the egg grading machine (not shown) to the reservoir conveyor 604 via the second end 610. The reservoir conveyor 604 then passes the eggs along the conveyor to the first end 608 and then to the egg loading section 606. The egg loading section 606 then receives an egg package (not shown) along a conveyor 612 and then deposits a plurality of eggs into the egg package. The eggs are deposited in the egg package such that the egg package is open and at least a portion of each of the eggs is accessible. In most instances, at least a portion of the eggs extend above the open egg package. Typically the eggs do not travel continuously down the conveyor belt of conveyor 612. Instead as each set of eggs are placed in the egg package at the egg loading section 606, a pause in the conveyor belt of the conveyor 612 occurs. During this pause or dwell time, the at least one laser source in the laser printing assembly 614 prints data on at least one of the eggs in the open egg carton. Preferably, the at least one laser source prints data on each of the eggs in the open egg carton.

The laser printing assembly may be configured on various configurations depending on the markings to be applied onto the eggs and the egg processing speed required in different embodiments or environments. For example, in one embodiment, the laser printing assembly 614 may be situated at the side of the conveyor 612 at a position where a portion of the egg carton is located below the at least one laser source. In another embodiment, the at least one laser source or associated beam delivery or beam deflecting or beam focusing elements may be mounted on a linear slide in the laser printing assembly 614 that moves parallel to the row of eggs during the dwell time and perpendicular to the direction of the conveyor belt of the conveyor 612. Thus, the at least one laser source prints from above the eggs contained in the egg package. The markings may include text, graphics, images, other types of indicia, and any combination thereof. In a preferred embodiment, the markings include freshness information, traceability data, or other types of relevant source information, or any combination thereof. In those embodiments in which the laser source prints from above the eggs, egg debris and/or broken eggs will not fall onto the laser source and therefore, will not cause downtime or impede print quality.

It is be understood that the at least one printing assembly may be positioned at any suitable location for marking on the food products and that the location referenced herein is only for example purposes. Further, the apparatus may include multiple printing assemblies and such printing assemblies may be configured or positioned as required for effective processing.

FIG. 8 is a diagram of one embodiment of the laser printing assembly 614 of FIGS. 6 and 7. The laser printing assembly 614 includes at least one laser source 802. The laser source 802 outputs a laser beam 804 that passes through a collimating and focusing lens 806, is then reflected off of mirror 808 to a galvanometer scanning head 810 that directs the laser beam to a specific location on the eggs passing thereunder. The laser printing assembly 614 may also include other components as necessary to interact with the apparatus 600 and apply the desired laser markings to the eggs. The laser printing assembly, which includes at least one laser source, preferably has vector scan and raster scan capability for applying the desired markings to the eggs. The laser printing assembly is in communication with an associated computer, controller, central processing unit, or the like (“computer system”) that controls the operation of the laser printing assembly and the at least one laser source contained therein.

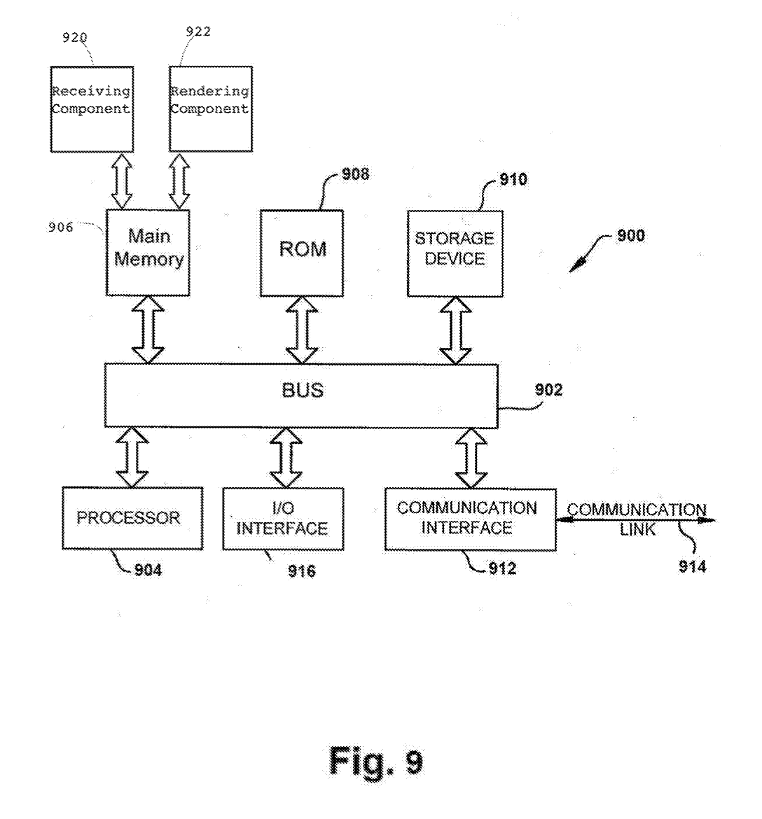

FIG. 9 illustrates an example of a computer system 900 upon which an example embodiment may be implemented. Computer system 900 is suitable for implementing the functionality of any embodiment of the apparatus 600 described herein in FIGS. 6 and 7.

Computer system 900 includes a bus 902 or other communication mechanism for communicating information and a processor 904 coupled with bus 902 for processing information. Computer system 900 also includes a main memory 906, such as random access memory (RAM) or other dynamic storage device coupled to bus 902 for storing information and instructions to be executed by processor 904. Main memory 906 also may be used for storing a temporary variable or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk, optical disk, SD memory and/or flash storage, is provided and coupled to bus 902 for storing information and instructions.

An aspect of the example embodiment is related to the use of computer system 900 to implement the method and system for applying markings to food products. According to an example embodiment, applying markings thereon are provided by computer system 900 in response to processor 904 executing one or more sequences of one or more instructions contained in main memory 906. Such instructions may be read into main memory 906 from another computer-readable medium, such as storage device 910. Execution of the sequence of instructions contained in main memory 906 causes processor 904 to perform the process steps described herein. One or more processors in a multi-processing arrangement may also be employed to execute the sequences of instructions contained in main memory 906. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 904 for execution. Such a medium may take many forms, including but not limited to non-volatile media, and volatile media. Non-volatile media include, for example, optical or magnetic disks, such as storage device 910. Volatile media include dynamic memory, such as main memory 906. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read. The instructions may optionally be stored on storage device 910 either before or after execution by processor 904.

The computer system 900 also includes a communication interface 912 coupled to bus 902, for providing a two-way data communication coupling computer system 900 to communication link 914. Communication link 914 typically provides data communication to other networks or devices. Although the illustrated example has one communication interface 912 and one communication link 914, those skilled in the art should readily appreciate that this is for ease of illustration, as the example embodiments described herein may have any physically realizable number of communication interfaces 912, and/or communication links 914. The server 900 may further include at least one input/output interface 916 connected to the bus 902 and in data communication with one or more user interface devices, such as a mouse, keyboard, monitor/screen, etc. (not explicitly shown).

Notably, while the illustrative embodiment described below shows a single computer system as performing the functions described herein, it is understood that the computer system 900 may comprise, either as a single computer system or as a collection of computer systems, one or more memories, one or more processors, and one or more network interfaces etc., as may be appreciated by those skilled in the art.

The computer system 900 is operable to control the operation of the printing assembly and the at least one printing source contained therein. The computer system 900 is also operable to receive and/or generate data files for producing or generating movement of the marking device to produce the desired markings. The computer system 900 is operable to control various parameters of the marking device, enabling optimization of the performance the marking device which enhances resolution of the applied markings.

In a preferred embodiment, the computer system 900 is operable to control the operation of the laser printing assembly and the at least one source contained therein. The computer system 900 is also operable to receive and/or generate data files containing vector and/or rector information for producing or generating movement of the marking device to produce the desired markings. The computer system 900 is operable to control various parameters of the laser beam, such as power, spot size, spot area, laser speed, pulse width, pulse frequency, and/or modulation frequency. This enables optimization of laser performance which enhances resolution of the applied markings. The magnitude and character of these parameters may be associated with the vector and raster information and stored in memory and programmably varied according to the desired results.

The computer system 900 is preferably interconnected with other computer systems, sensors devices, and other devices associated with other machines, systems, networks, and the like that interact with the apparatus 600 as set forth in FIGS. 6 and 7. For example, the computer system 900 is preferably interconnected with the computer system that controls and monitors the operation of the egg-handling machine 602. The computer system preferably receives environmental and product information from the egg-handling machine, such as wash water temperature, rinse water temperature, wash water pH values, egg origin and characteristic information, and the like. The computer system also preferably receives information from position sensors which monitor the operating status of all important moving components of the apparatus 600.

In one embodiment, the environmental information, product information, positional information, and other relevant processing information may be obtained using image capturing devices, machine-readable or human-readable sensors and identifiers, radio frequency identification transponders (RFID) or other transmitting sensors, time stamps or biometric identification, object recognition, texture definition, database management, and other software, data interface equipment consisting of serial, parallel, or network communication, binary data such as switches, gates, push buttons, current sensors, as well as additional forms of data input. The computer system 900 processes the obtained data and uses such data in the control and operation of the printing assembly as well as the associated egg-handling machine. By adjusting the characteristics of the marking applied thereon, a more consistent mark is achieved and variations of marking quality between different types of eggs, environments, and the like may be reduced and/or eliminated.

Egg origin and characteristics of the eggs on which the marking is to be applied, or the environmental or processing conditions to which the eggs are subject, may affect the quality of the mark to be applied thereon. These factors include, but are not limited to:

Shell composition (chemical);

Shell composition (mechanical features);

Shell thickness;

Percentage of cuticle remaining;

Shell strength;

Species (chicken, ducks, turkeys, etc.);

Breed of bird;

Feed for bird;

Water source for bird;

Barn temperature;

Molt cycle;

Age of bird;

Age of the egg

Color of egg;

Egg weight (individual and package)

Egg grade

Egg surface temperature at time of lasing;

Egg wetness at time of lasing;

Egg internal temperature at time of lasing;

Thermal conductive coefficient of egg shell;

Curvature of egg relative to the marking;

Egg washing process parameters;

Egg rinsing parameters;

Egg drying parameters;

Temperature and humidity in the packing facility;

Time of day;

Egg packaging parameters;

Peak temperature reached;

Degree of focus of the laser during marking;

Movement of egg during marking;

Temperature of air local to marking point;

Effectiveness of vacuum system.

Data relating to the characteristics associated with eggs or the processing or environmental conditions may be obtained by any suitable means. For example, the egg origin and characteristic information of the eggs may be obtained from the source providing the eggs, inspection/examination prior to the processing, data obtained from previous processing of similar types of eggs, data received or obtained by the computer system 900 during monitoring of the marking process, or any other means. Data relating to the environmental conditions, processing parameters, and the interaction of the laser with the egg shell may be obtained from previous processing of similar types of eggs, data received or obtained by the computer system 900 during monitoring of the marking process, or any other means. The computer system preferably stores the data in memory and uses such data as necessary in the control and operation of the printing assembly as well as in the control and operation of the egg-handling machine.

In accordance with an embodiment of the present disclosure, the performance or characteristics of the marking device may be adjusted in response to selected characteristics of the food product in order to optimize the marking applied thereon. Further, the interaction of the marking device with the food product may be monitored by any suitable means and the characteristics of the marking may be adjusted in response to such parameters. By adjusting the characteristics of the marking applied thereon, a more consistent mark is achieved and variations of marking quality between different types of eggs, environments, and the like may be reduced and/or eliminated.

In a preferred embodiment, the laser performance parameters may be suitably set or adjusted based on the egg characteristics, environmental conditions, processing conditions, interaction with the laser and the egg shell, content to be applied thereon, and combinations thereof. In a preferred embodiment, the computer system 900 controls various parameters of the laser printing assembly and the at least one laser printing head to optimize the laser markings to be applied to the eggs. The parameters that may be set or adjusted include, but are not limited to:

Laser power;

Spot size;

Depth of field;

Speed of traverse of the laser beam over the surface of the object being marked;

Number of passes of the laser beam over the surface of the object being marked;

Dwell-time between passes;

Power settings within/between passes;

Spot size of laser beam within/between passes;

Speed of traverse within/between passes;

Order of passes;

Dwell-time in corners of characters;

Configuration of character fonts;

Configuration of any graphical objects to be marked;

Localized heat buildup;

Laser pulse frequency;

Laser wavelength.

The laser performance parameters may be set or adjusted prior to the laser marking process, during the laser marking process in response to data obtained during processing, or any combination thereof. The laser performance parameters may be set or adjusted per egg, per batch, per run, or any combination thereof. Preferably, the laser performance parameters are adjusted to optimize the laser marking applied thereon such that a more consistent marks is achieved and variations in marking quality are reduced and/or eliminated.

In one embodiment, at least a portion of the eggs are examined or analyzed during and/or after the laser marking process to determine the position and/or characteristics of the eggs that are to be marked and/or the quality and integrity of the information that is marked on the eggs. Any number of environmental and processing conditions may be analyzed to produce a specific optimized or improved marking on the eggs in response to the analyzed conditions. It is understood that it may be undesirable to analyze each egg for cost and processing time reasons. Therefore, in some embodiments, a portion of the eggs processed are routed to a quality analysis station for analysis and examination prior to, during, and/or after processing thereof.

In some embodiments, a machine vision system 616 may be configured and arranged so as to the examine the position and characteristics of eggs that are to be marked and/or the quality and integrity of the information that is marked on the eggs. In some embodiments, one or more machine vision observation units or imaging sensors 618 may be positioned, for example, adjacent the laser printing assembly 614. In other embodiments, the one or more imaging sensors 618 may be located elsewhere to allow for adequate observation. In a preferred embodiment, the machine vision system 616 is operable to control the operation of the one or more imaging sensors 618 and to receive image data obtained from the one or more imaging sensors 618. The machine vision system 616 is also operable to receive and transmit data to the computer system 900. In one embodiment, the system as disclosed herein may be stopped if the machine vision system 616 determines that the mark quality has fallen below a certain threshold. In some embodiments, such a system may be a closed-loop such that feedback from the machine vision system 616 may be used to control the printing assembly 614 so as to improve the quality and reliability of the process.

As used herein, the phrase “imaging sensor” refers to a component of a vision system that captures image data, e.g., a camera or other image capturing device. In machine vision systems, one or more imaging sensors are configured and arranged to capture image data of one or more areas of interest within a facility. Imaging sensors include analog video cameras, digital video cameras, color and monochrome cameras, closed-circuit television cameras, charge-coupled device sensors, complementary metal oxide semiconductor sensors, analog and digital cameras, PC cameras, pan-tilt-zoom cameras, web cameras, infra-red imaging devices, and any other devices that can capture image data. The selection of the particular camera type and selection of the connected machine vision system for a particular facility may be based on factors including environmental lighting conditions, the frame rate and data acquisition rate, and the ability to process data from the lens of the camera within the electronic circuitry of the camera control board, the size of the camera and associated electronics, the ease with which the camera can be mounted as well as powered, the lens attributes which are required based on the physical layout of the facility and the relative position of the camera to the area of interest, and the cost of the camera.

Data obtained prior to, during, and/or after processing of the eggs is suitably stored in memory for later use. The obtained data may be stored in memory local to the egg processing facility and/or remotely by any suitable means. The obtained data may be accessed and analyzed via any suitable means, such as statistical analysis, to determine any variations, trends, patterns, and the like.

As discussed above, the computer system 900 is operable to control the operation of the printing assembly and the at least one printing head contained therein. The computer system 900 is also operable to receive and/or generate data files for producing or generating movement of the marking device to produce the desired markings. In particular, the computer system 900 is operable to control the printing assembly and the at least one printing head contained therein to produce markings applied on the food product. The markings may include text, graphics, images, other types of indicia, and any combination thereof. In a preferred embodiment, the markings include freshness information, traceability data, historical processing information, other types of relevant source information, or any combination thereof (“source information”). The markings may also include other content, such as advertisements, sponsored images, or other types of promotional material (“promotional information”).

The computer system 900 receives and/or generates the data files for producing the markings on the eggs via any suitable means. In one embodiment, the computer system 900 generates the data files based on source information, promotional information, other relevant information, and any combination thereof (collectively referred to as “content information”) received from or generated by an associated user, other computer system, device, network, or the like. In a preferred embodiment, the computer system includes a content information receiving component 920, which is any suitable software that enables the computer system 900 to receive content information. In a preferred embodiment, the computer system 900 further includes a content information rendering component 922, which is any suitable software that enables the computer system to render and/or format content information to be applied to the food products. It is to be understood that the content information rendering component 922 suitably renders, formats, or otherwise modifies the received content information for suitable marking onto the food products. As used herein, the phrase “render” may be used to describe such rendering, formatting, or modification of the content.

It is to be understood that content information receiving component 920 and content information rendering component 922 may suitably be implemented as logic operable to be executed by processor 904. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In a preferred embodiment, the computer system 900 receives the content information from an associated user, other computer system, device, network, or the like via the content information receiving component 920. Content information may be provided to the computer system through the input/output interface 916 via a suitable user interface device, through the communication interface 912 via the communication link 914, via a computer readable medium, or combinations thereof.

In one embodiment, the content information receiving component 920 may include the functionality to allow an associated user to select parameters, features or other options for the rendering of the content information provided (“rendering options”). For example, the user may be able to select parameters related to text which is to be rendered (i.e., font size, font type, font color, resolution, complexity, spacing, placement, etc.); and/or images which are to be rendered (i.e., image size, image type, image color, image resolution, image complexity, spacing, placement smoothing operations, etc.). The user may also be able to select parameters related to printing performance parameters, such as power, spot size, spot area, printing speed, number of passes, frequency, and the like. The user may further be able to select parameters associated with the eggs and/or packaging to which the content information is to be applied, such as specific egg(s) on which the information is to be applied, specific egg container(s) on which the information is to be applied, and the like. The content information provided and/or the selected rendering options may be stored in memory for future use. The content information and rendering options may be stored in memory local to the egg processing facility and/or remotely by any suitable means, and may be accessed and analyzed via any suitable means, such as statistical analysis, to determine any variations, trends, patterns, and the like.

While reference to content information being provided from a user for rendering onto a food product, it is to be understood that content information may be provided from multiple users or sources, and the content information from each of the users or sources may be rendered and applied to the food product. Further, an egg may have multiple markings applied thereon, wherein the content information for each marking is not provided from the same user or source.

The content information provided to the content information receiving component 920 is transmitted to the content information rendering component 922 to be rendered in accordance with the selected rendering options for applying such content information to the food product. The content information is formatted, modified, or otherwise changed for suitable marking of the information on the food product. The formatting or changing thereof is preferably based on the characteristics of the text and/or images to be rendered, the printing performance parameters, the food product characteristics, the environmental and processing conditions, and any combination thereof. The content information as rendered by the content information rendering component 922 is then applied or marked onto the food product by the printing assembly in accordance with selected performance parameters.

As discussed above, in a preferred embodiment, the content information to be marked on the food product includes source information, promotional information, or any combination thereof. The source information is suitably comprised of freshness information, traceability data, historical processing information, other types of relevant source information, or any combinations thereof. The source information is used to track and/or access historical data associated with processing for such food product. The historical data may include, but is not limited to, food source location details, food source environmental and processing conditions, food processing facility details, food processing environmental and processing conditions, food product characteristics, regulatory compliance information, food product distribution details, food product distribution environmental and processing conditions, other relevant information, and any combination thereof.

The freshness information includes data related to the freshness and/or expiration of the associated food product. The freshness information may include food processing data, such as when and where the food product was harvested, produced, packaged, processed, and the like; use data, such as use by date, best by date; sell by date, enjoy by date, and the like; and any combination thereof. For example, the freshness information marked on an egg may include data as to when the egg was harvested and/or packaged as well as a use by date indicating the latest date as to which the egg should be consumed.

The freshness information marked thereon may be in any suitable format to efficiently provide the relevant information to the consumer, retailer, or other interested party. For example, the egg may be marked with harvest date information and use by date information. The date information may be in month/date/year format, such as “Use by Feb. 1, 2016”. The date information may also be marked using a Julian Date format, wherein each day of the year is assigned a number between 001 to 365 (001 to 366 for leap years), such as if the egg was harvested on February 1, the data related to the harvest date is marked as 032.

Traceability data includes data that may be used to track and/or access historical data associated with processing the food product having the code marked thereon. The traceability data may include data related to food source location details, food processing facility details, food processing environmental and processing conditions, food product characteristics, regulatory compliance information, food product distribution details, any other relevant information, and any combination thereof. For example, traceability data marked on an egg may include information related to the egg producer, egg processing facility information, egg processing environmental and/or processing conditions, egg characteristics, packaging information, distribution/transportation details from source to consumer, and any combination thereof. The historical data may include, but is not limited to, food source location details, food source environmental and processing conditions, food processing facility details, food processing environmental and processing conditions, food product characteristics, regulatory compliance information, food product distribution details, food product distribution environmental and processing conditions, other relevant information, and any combination thereof. It is to be understood that freshness information may be marked separately on the food product or included as part of traceability data marked on the food product.

The traceability data marked on the food product may be in any suitable format to efficiently provide the relevant information to the consumer, retailer, food product source, food processing facility, distributor, governmental entity, or other interested party. In a preferred embodiment, the traceability data may be encoded in an alphanumeric character set. In an example implementation, the traceability data is an alphanumeric character set that is designed to allow a large amount of data to be contained in the traceability data within the constraints of the limited character set. In a more preferred embodiment, the traceability data is encoded using a Base 27 alphanumeric character set comprised of numeric characters 1-9 and uppercase letters ACDEFHJKLMNPRTVWXY. Moreover, potentially-confusing or mis-read numbers and uppercase letters when printed, such as “Z,” (potentially confused with “2”) “S,” (potentially confused with the number “5”), “B,” (potentially confused with the number “8”), “I” (potentially confused with the number “1”) and the letters “0” and “Q” and the number zero (potentially confused with the letter D) are not included in the character set. The traceability data is generated and/or encoded by any suitable means.

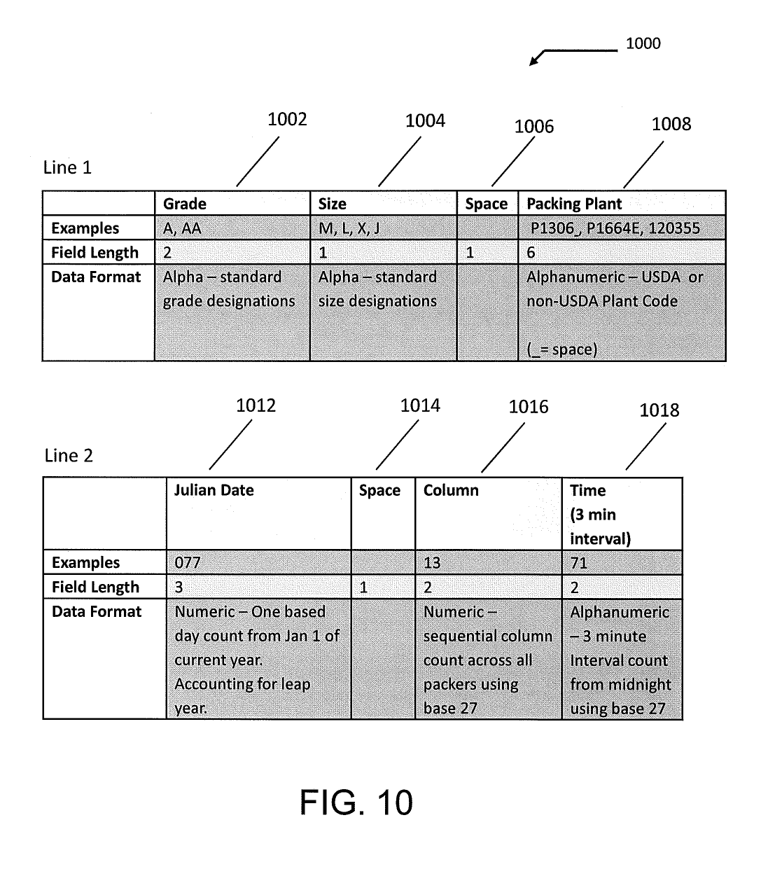

FIG. 10 is a schematic diagram 1000 illustrating an example embodiment of traceability data to be marked on the food product, such as an egg shell, together with an illustration of the parameters of the information to be included therein. As shown in FIG. 10, the traceability data is an alphanumeric code comprised of up to 16 characters and 2 spaces formatted into two lines to be marked on the egg shell. Line 1 of the code has 4 elements: the grade 1002 consisting of up to 2 uppercase letters; size 1004 consisting of 1 uppercase letter; a space 1006; and packaging facility information 1008 consisting of up to 6 alphanumeric characters. Line 2 has 4 elements: Julian Date data 1012 consisting of 3 numeric characters; a space 1014; column information 1016 consisting of 2 alphanumeric characters using a Base 27 character set; and time information (3 minute interval) 1018 consisting of up to 2 alphanumeric characters using a Base 27 character set. Examples of traceability data as illustrated in FIG. 10, intended for marking on selected egg shells during processing thereof, is suitably “AAJ P1664E” for Line 1 and “077 1371” for Line 2.

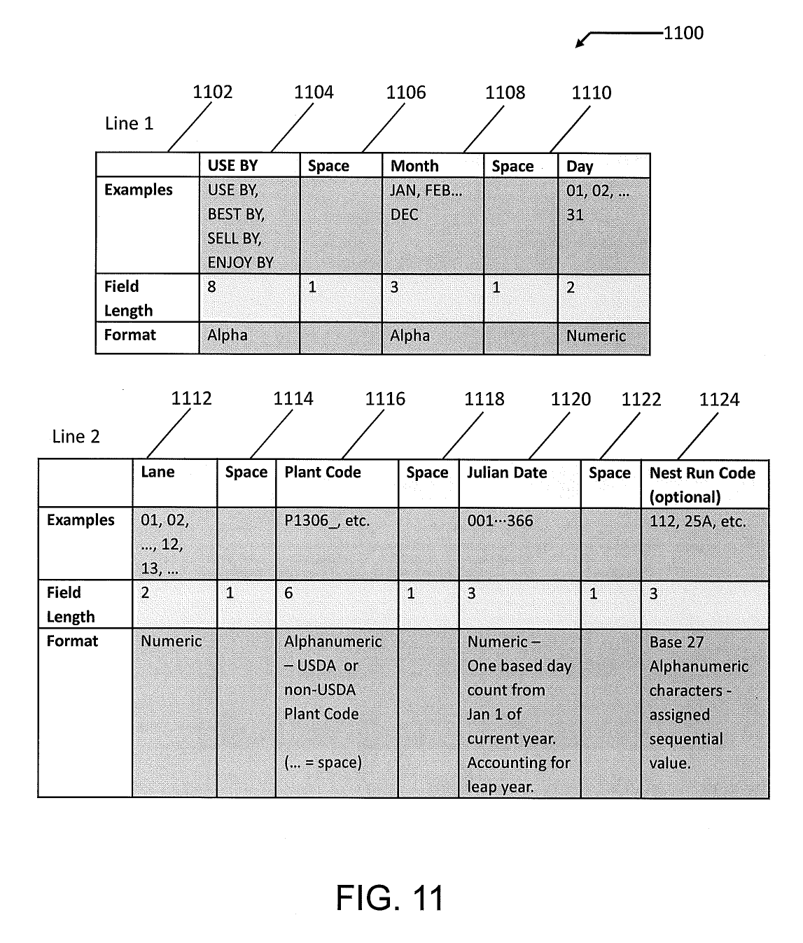

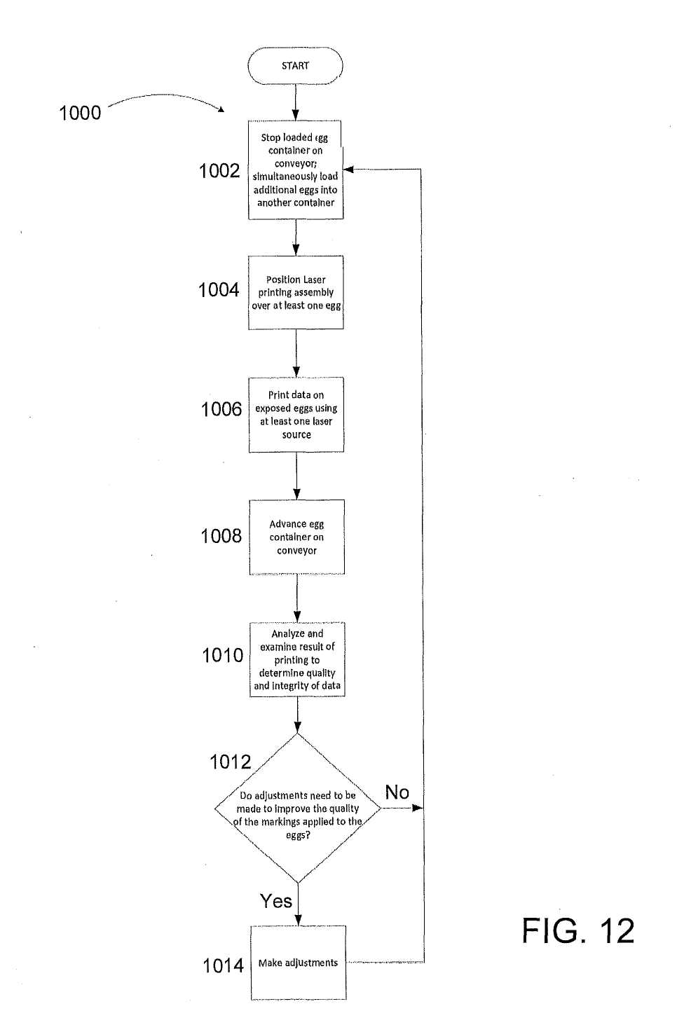

FIG. 11 is a schematic diagram 1100 illustrating an example embodiment of traceability data to be marked on the packaging of a food product, such as an egg carton, together with an illustration of the parameters of the information to be included therein. As shown in FIG. 11, the traceability data is an alphanumeric code comprised of 20-23 characters and 4-5 spaces formatted into two lines to be marked on the egg container. Line 1 of the code has 5 elements: Use By data 1102 consisting of 8 uppercase letters; a space 1104; month 1106 consisting of 3 uppercase letters; a space 1108, and day 1110 consisting of 2 alphanumeric characters. Line 2 has 7 elements: packaging lane information 1112 consisting of 2 numeric characters (with leading zeros); a space 1114; packaging facility information 1116 consisting of up to 6 alphanumeric characters; a space 1118; Julian Date data 1120 consisting of 3 numeric characters; a space 1122; and egg source identification data for eggs sourced from outside the egg packaging facility (“nest run data”) 1124 consisting of 3 alphanumeric characters using a Base 27 character set. Examples of traceability data as illustrated in FIG. 11, intended for marking on selected egg cartons during processing thereof, is suitably “USE BY OCT 27” for Line 1 and “11 P1306 325” for Line 2. Some traceability data may optionally also include the year (1 space and 4 digits) at the end of line 1, to more completely specify the date being represented. An example include all optional elements added to a traceability code is suitably “USE BY OCT 27 2015” for Line 1 and “11 P1306 325 166”.

As discussed above, the computer system 900 receives and/or generates the data files for producing the source information to be marked on the food products via any suitable means. In one embodiment, the computer system 900 generates the data files based on content information, including source information, received from or generated by an associated user, other computer system, device, network, or the like via the content information receiving component 920. The content information provided therein is transmitted to the content information rendering component 922 for rendering in accordance with the selected rendering options, and the rendered content is applied or marked onto the food product by the printing assembly.

FIG. 12 is an example flow diagram 1200 of laser marking on eggs with the apparatus 600 as shown in FIGS. 6 and 7 in accordance with an example implementation. An egg carton stops for a predetermined period of time under the egg loading section 606 which loads the eggs into an egg container. Simultaneously while an egg container is being loaded by the egg loading section 606, a loaded egg container is stopped on the conveyor 612 under the laser printing assembly 614 as shown at 1202. The at least one laser source contained within the laser printing assembly 614 is positioned over at least one egg in the egg container as shown at 1204. The at least one laser source prints content information, such as source information, onto the exposed eggs in accordance with the desired rendering options and laser performance parameters as shown at 1206. The egg container is then advanced on the conveyor 612 as additional eggs are placed in an egg container by the egg loading section 606 as shown at 1208.

At 1210, at least a portion of the eggs having data printed thereon are analyzed and examined as discussed above to determine the quality and integrity of the data printed thereon as well as the structural integrity of the eggs. In response to such analysis and examination, the computer system 900 or any other suitable means determines if any of the laser performance parameters, environmental conditions, and/or processing conditions need to be adjusted to improve the quality of the markings applied to the eggs as shown at 1212. If it is determined that certain parameters and/or conditions need to be adjusted, such adjustments are made by any suitable means as shown at 1214. The next container of eggs is then processed according to such parameters and laser marking process continues again as shown at 1202. If it is determined that the parameters do not need to be adjusted, the laser marking continues again as shown at 1202.

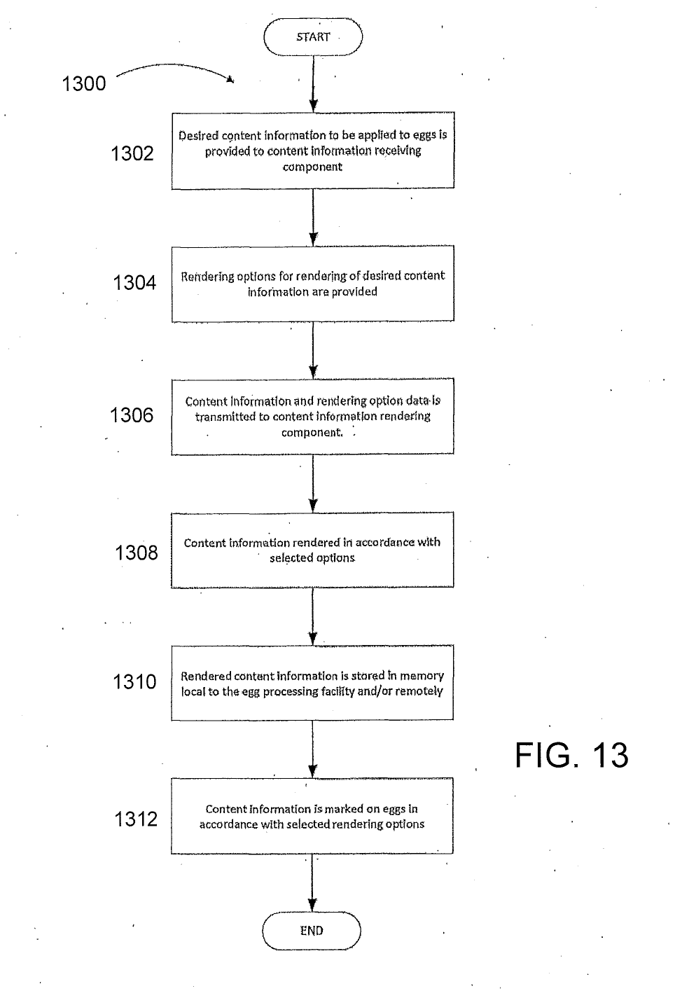

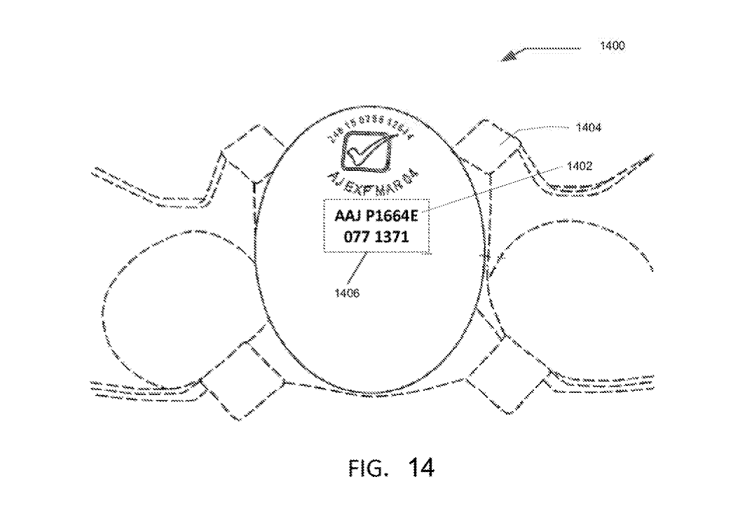

FIG. 13 is an example flow diagram 1300 of marking content information, including source information on eggs with the apparatus 600 as shown in FIGS. 6 and 7 in accordance with an example implementation. At 1302, the desired content information to be applied to the eggs is provided to the content information receiving component 920 by any suitable means. At 1304, the rendering options for the rendering of the desired content information are provided. The rendering option data is then associated with the content information and used in the marking of the content information on the eggs. The content information as well as the rendering option data is transmitted to the content information rendering component 922 as shown at 1306. The content information is rendered by the content information rendering component 922 in accordance with the selected options as shown at 1308. At 1310, the rendered content information is stored in memory local to the egg processing facility and/or remotely by any suitable means for future use. At 1312, the content information is marked on the eggs in accordance with the selected rendering options.

FIG. 14 is illustration of an egg 1400 having traceability data 1402 marked on the egg shell in accordance with the present invention, when the egg is located in an associated egg carton 1404. Preferably, the traceability data is marked on the egg shell at such a location 1406 that when the egg 1400 is oriented in the carton, the traceability data is immediately apparent to a consumer opening the carton. The traceability data may be marked on the egg prior to placement in the carton or after placement in the carton. This allows the consumer to easily locate and view the traceability data 1402 as well as any other information marked thereon.

In a preferred embodiment, at least a portion of the source information is collected and stored in memory for later use. The source information may be collected, consolidated, and then analyzed for any suitable purpose, such as to improve processing control and output, determine output and performance characteristics, improve, determine trends, determine or verify regulatory compliance, identify risks (i.e., processing conditions, environmental conditions, contamination, source, etc.), support product recall procedures, provide source verification, and the like. Source information may be collected from information marked on multiple food products, multiple processing runs on a device or system, multiple marking devices or systems within a processing facility, multiple processing facilities, multiple distribution systems, multiple food sources, and the like, or any combination thereof.

The collected information is then consolidated and stored in memory for later use by authorized users. The consolidated data may be stored locally and/or remotely by any suitable means. In a preferred embodiment, the present disclosure provides a cloud-based system for collecting, consolidating, and disseminating the source information. The source information contained therein may be analyzed with respect to food source location details, food processing facility details, food processing environmental and processing conditions, food product characteristics, food product distribution details, regulatory compliance details, and the like.

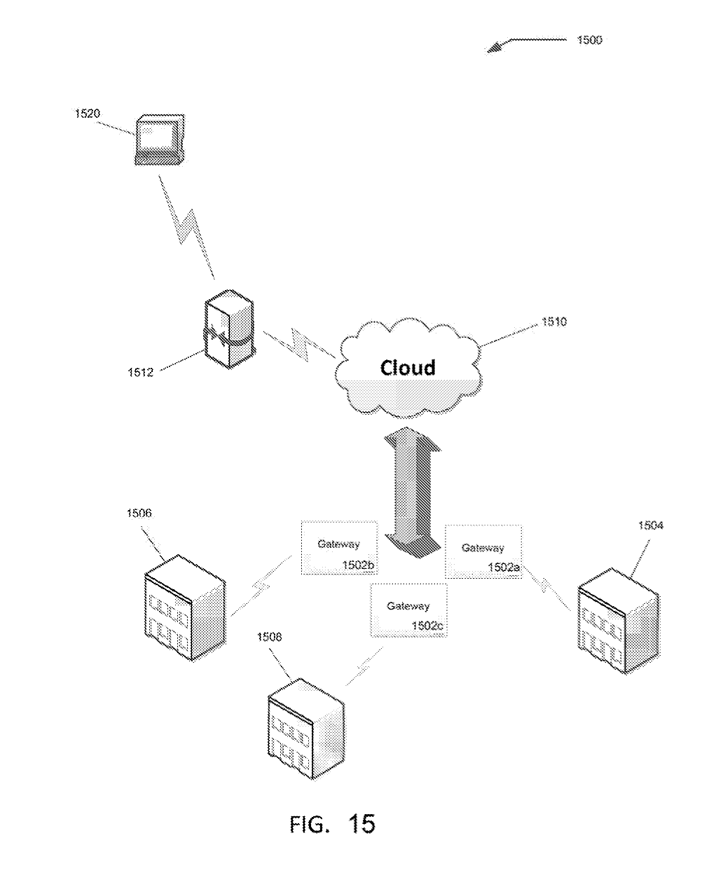

FIG. 15 illustrates an exemplary block diagram of a cloud-based approach for connecting numerous remote devices or systems with a remote storage location having a database or other relational storage component for storing data related to the operation of one or more food product processing systems. As an example embodiment, FIG. 15 illustrates a block diagram 1500 of a cloud-based approach for storing data related to source information marked on egg shells of eggs processed by one or more egg processing facilities. In FIG. 15, gateway 1502a is in communication with egg processing facility 1504 and gateway 1502b is in communication with egg processing facility 1506. Egg processing facility 1506 also processes eggs received from egg processing facility 1508. Egg processing facility 1508 is an off-line facility that transports eggs to egg processing facility 1506, which in turn processes the eggs and transmits the relevant data to gateway 1502b. For purposes of this example, all three egg processing facilities 1504, 1506, and 1508 may have received nest run eggs. Egg processing facilities 1504 and 1506 will apply markings to at least a portion of the eggs processed therein. Such markings preferably include source information, such as freshness information, traceability data, historical processing data, and other relevant source information as discussed above.

In some embodiments, a unique identifying number may be created at the source farm 1508 when “nest run” eggs have been processed, ready for sale and/or shipping to an egg packing facility 1504 or 1506. One such unique identifying number is created per pallet of eggs processed (“pallet” designating the smallest unit of sale for such nest run eggs). This unique identifying number may be included on a label in the form of a machine readable code, a human-readable code or a combination of both. A suitable printing device at the source farm may print a label that is attached to the pallet, or the number may be printed or written directly onto the pallet identifying paperwork. Additionally this unique identifying number is uploaded to a remote storage location 1512 via the via the Gateway 1502c and the cloud 1510. In some embodiments, if processing parameters and/or conditions are monitored and found to be out of compliance, the unique identifying number and associated label may not be printed or made available at the source farm 1508.

At the time of shipment of the nest run eggs from the source facility 1508 to the egg processing facility 1504 or 1506, a unique identifying number may be created specific to the shipment. This unique identifying number may be included with the delivery note, invoice or other shipping paperwork that accompanies the eggs during transportation. This unique identifying number may be included in the form of a machine readable code, a human-readable code or a combination of both. A suitable printing device at the source farm 1508 may print a label that is attached to the shipping paperwork, or the number may be printed or written directly onto the paperwork. Additionally this unique identifying number will be uploaded to a remote storage location 1512 via the Gateway 1502c and the cloud 1510. In some embodiments, all pallet-level unique identifying numbers included with the shipment may be scanned or otherwise identified, and associated with the shipment-level unique identifying number, in a data entry in the remote data storage 1512.

These unique identifying numbers, whether pallet-level or shipment-level, form part of a series of data entries in the remote storage location 1512 that will include the unique identifying number, and may include the quantity of eggs in the pallet or shipment, processing records for the nest run eggs, such as location, time of processing, environmental conditions at the time of processing, egg processing equipment status at the time of processing, and any other information relating to the nest run eggs that may be required to determine whether such eggs were processed in accordance with regulations.

In some embodiments, when the ‘nest run’ eggs have completed transportation to the egg processing facility 1504 or 1506, the unique identifying number contained within the shipping paperwork is entered via a user interface, bar-code scanner or other suitable data collection device, and the related content stored in the remote storage location 1512 is examined to assure compliance with regulations. In some embodiments, the results of this examination may determine whether the ‘nest run’ eggs are accepted by the receiving facility, or rejected for non-compliance (one such reason would be that the eggs are too old to be processable at the receiving facility). A data entry is made at the remote storage location 1512 including the unique identifying number for the shipment, and the date and time and location of receipt, and may include a designation for acceptance or rejection if applicable. Such ‘nest run’ eggs may then be stored suitably at the egg processing facility 1506 or 1504 for later processing and packing into cartons. In some embodiments, each pallet-level unique identifying number may be scanned or otherwise recorded as the pallets are offloaded from the transportation means into the egg storage facility at the receiving farm 1504 or 1506. In such a system, a data entry is made at the remote storage location 1512 including the pallet-level unique identifying number, and the date and time and location of storage.

In some embodiments, when the ‘nest run’ eggs are required to be processed and packed into cartons, the unique identifying number from the shipment, or the unique identifying number from the pallet if available, is entered again into the computer system via suitable means, or recalled via a user interface from a list of available Nest Runs that is downloaded from the remote storage location 1512 to the egg processing facility 1504 or 1506. The data selection process, however achieved, causes a set of information relating to the batch of nest run eggs to be utilized by the Gateway 1502b, or other computer systems, in determining the marks to be applied to eggs, or to egg cartons. Such marks will designate the source of the eggs as described above. All associated processing and source farm information is linked via a data entry in the remote storage facility 1512 to the date, time and location of use of the nest run eggs. Such data can later be provided as applicable to the consumer, retailer, distributor, regulator or other interested party, via a remote data terminal 1520.

The source information as it is collected may be transmitted through the cloud 1510 to a remote storage location 1512. The collected source information is consolidated and archived, and is available for remote analysis thereof for any suitable purpose, such as to improve processing control and output, determine output and performance characteristics, improve, determine trends, determine or verify regulatory compliance, identify risks, support product recall procedures, provide source verification, and the like. In some embodiments, a portion of the data collected and/or analyzed may flow back by way of the cloud 1510 through gateway 1502a and/or 1502b to one or more of the egg processing facilities for use thereby. The remote storage location 1512 may be accessible remotely to consumers, retailers, egg providers, egg processing facilities, governmental entities, and other interested parties by any suitable remote communication device as illustrated by 1520. Preferably, access to the remote storage device is only after suitable authentication and/or encryption processes.

It is to be understood that the need to keep proprietary data secure, the fear of competition, and other factors have prevented trading partners from adequately sharing the required information to ensure that food traceability information is in a form that best protects the food safety interests of the public. Market demand has caused some agricultural producers to misrepresent the true source of some or all of their agricultural produce, including eggs. In an embodiment of the present disclosure, traceability data or codes generated using 256 bit high density codes (or other high density codes) are generated in accordance with the disclosure herein on a daily basis and are applied to labels on shipments leaving each facility. Upon receipt at the destination, the unique codes are correlated to source and volume, and include basic information relating to the “Compliant” or “Non-Compliant” nature of the shipment as determined by the present disclosure. This present disclosure allows the interoperability and confidential disclosure objections of agricultural producers to be overcome while allowing for fully traceable products within the supply chain.

It is appreciated by those skilled in the art that the cloud-based approach shown in FIG. 15 is only an exemplary topology diagram of a cloud-computing methodology and that for purposes of connecting numerous remote devices herein, a cloud-based implementation may take other forms and include other components as necessary.

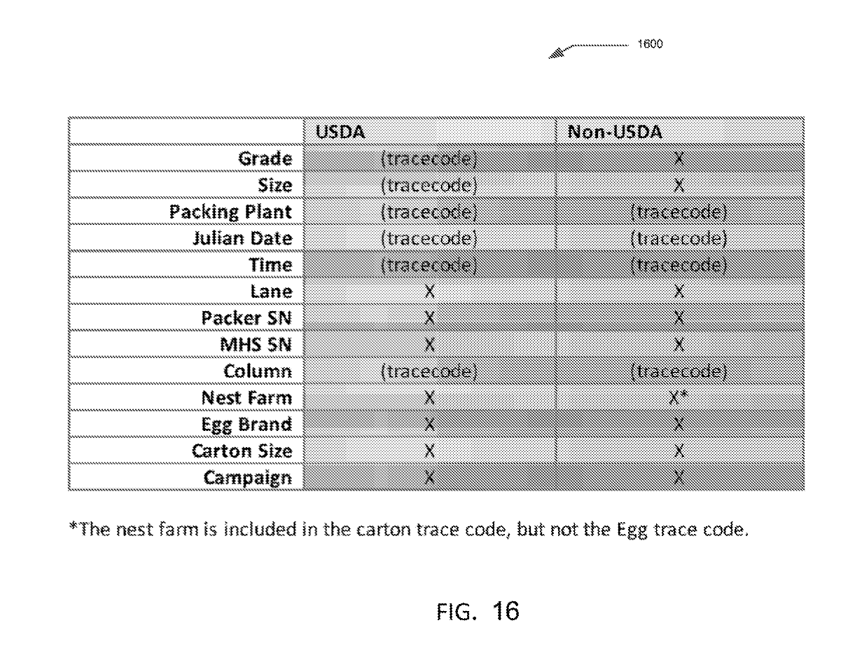

FIG. 16 is a schematic diagram illustrating an example of a data entry 1600 in a database or other relational storage component containing traceability data and other relevant data as shown. Such a database is one of several that may be located at a remote storage location 1512, and accessed with respect to traceability data marked on the egg. In data entry 1600, all items labeled as (trace code) constitute static lookup, i.e., characters that directly represent specific information, as defined in the traceability data set forth in FIGS. 10 and 11. For example, “MAR” directly represents the month March. Items marked with an “X” denote data that is retrieved via database lookup based on the static data: packaging facility information, Julian Date data, time information, and column information in the traceability data. Accordingly, these four elements may together identify a specific, unique point in time at a specific egg processing facility, and may also point to a specific data entry 1600 in the database that can be accessed to retrieve additional data related to that point in time (i.e., the items marked with an “X” in FIG. 16).

It should be noted that traceability data differs between USDA-approved carton marking and non-USDA carton marking, as illustrated in FIG. 16. The Non-USDA format has the advantage of requiring fewer characters which requires less time for printing, in turn allowing more eggs to be marked and processed in a given time interval.

As for the time information, the three minute interval, in combination with other traceability data, enables determination of the marketing campaign (which may be associated with the graphical or text-based information marked on the egg), egg source, and other information related to the marked egg to be traceable within 180 seconds of its packaging. A job or nest run is very likely to change part way through a 3 minute interval. In order to assure the time information printed on the egg represents the actual product's history, when a new job or nest run starts being processed, the system will switch immediately to the time information corresponding to the next 3 minute interval.

Having thus described certain embodiments of systems and methods for practicing aspects of the present disclosure, it is to be appreciated that various alterations, modifications, and improvements will readily occur to those skilled in the art. Such alterations, modifications, and improvements are intended to be part of this disclosure, and are intended to be within the spirit and scope of this disclosure

1. A system for marking individual objects with selected content at a marking station while the objects travel along at least one path through a processing system, the system comprising:
at least one processor operable to control marking of individual objects;
at least one marking unit operatively coupled to the at least one processor and controlled in part by the at least one processor, the at least one marking unit positioned adjacent at least one path along which the objects are conveyed, the at least one marking unit operable to mark the objects as the objects pass through the marking station; and
a non-transient memory operatively coupled to the at least one processor and operable to store data associated with the marking of the objects;
at least one input/output interface operatively coupled to the processor;
wherein the least one processor is operable to:
obtain source data associated with at least one of at least one characteristic of the individual objects to be marked, at least one parameter associated with the origin of the individual objects to be marked, at least one operational parameter of the processing system, at least one operational parameter of the at least one marking system, and combinations thereof;
obtain content marking parameters comprising at least one of content to be marked thereon, at least one rendering parameter associated with marking of the content thereon, at least one characteristic of the individual objects to be marked, and combinations thereof;
render the selected content in accordance with at least a portion of the content marking parameters, wherein the selected content includes at least a portion of the source data; and
mark the individual objects with the selected content by the at least one marking unit in accordance with at least a portion of the content marking parameters.

2. The system of claim 1, wherein the selected content to be marked on the objects comprises at least one of text, graphics, and any combination thereof, and includes source data comprised of at least one of freshness information, traceability data, historical processing data, and any combination thereof.

3. The system of claim 2, wherein the freshness information includes at least one of production data, use data, and combinations thereof, wherein the production data includes data associated with at least one of the harvest, production, and packaging of the objects, and combinations thereof, wherein the use data includes data associated with time periods in which the objects should be used.

4. The system of claim 2, wherein the traceability data is used to track data associated with the individual objects and processing performed thereon, wherein the data includes at least one of source location details, processing facility details, processing environmental and processing conditions, distribution environment and processing conditions, object characteristics, commercial and regulatory compliance details, and combinations thereof.

5. The system of claim 2, wherein the historical processing data includes at least one of source location details, source environmental and processing conditions, processing facility details, processing environmental and processing conditions, distribution details, distribution environment and processing conditions, object characteristics, commercial and regulatory compliance details, and combinations thereof.

6. The system of claim 2, wherein the at least one processor is further operable to store at least a portion of the selected content in memory.

7. The system of claim 6, wherein at least a portion of the memory is implemented in a cloud-based component communicatively coupled to the at least one processor, and is operable to store at least a portion of the selected content, wherein at least a portion of the selected content is stored in relation to the source data associated therewith.

8. The system of claim 7, wherein the at least one processor is further operable to receive a request from an associated user, via the at least one input/output interface to retrieve selected content and the source data associated therewith stored in the memory, and to retrieve the requested content.

9. The system of claim 8, wherein the at least one processor is further operable to retrieve the requested content based on at least one of freshness information, traceability data, historical processing data, and combinations thereof associated with the content.

10. A method for marking individual objects with selected content at a marking station while the objects travel along at least one path through a processing system, wherein the at least one marking unit is positioned adjacent at least one path along which the objects are conveyed, the at least one marking unit operable to mark the objects as the objects pass through the marking station, the method comprising:
obtaining source data associated with at least one of at least one characteristic of the individual objects to be marked, at least one parameter associated with the origin of the individual objects to be marked, at least one operational parameter of the processing system, at least one operational parameter of the at least one marking system, and combinations thereof;
obtaining content marking parameters comprising at least one of content to be marked thereon, at least one rendering parameter associated with marking of the content thereon, at least one characteristic of the individual objects to be marked, and combinations thereof;
rendering the selected content in accordance with at least a portion of the content marking parameters, wherein the selected content includes at least a portion of the source data; and
marking the individual objects with the selected content by the at least one marking unit in accordance with at least a portion of the content marking parameters.

11. The method of claim 10, wherein the selected content to be marked on the objects comprises at least one of text, graphics, and any combination thereof, and includes source data comprised of at least one of freshness information, traceability data, historical processing data, and any combination thereof.

12. The method of claim 11, wherein the freshness information includes at least one of production data, use data, and combinations thereof, wherein the production data includes data associated with at least one of the harvest, production, and packaging of the objects, and combinations thereof, wherein the use data includes data associated with time periods in which the objects should be used.

13. The method of claim 11, wherein the traceability data is used to track data associated with the individual objects and processing performed thereon, wherein the data includes at least one of source location details, processing facility details, processing environmental and processing conditions, distribution environment and processing conditions, object characteristics, commercial and regulatory compliance details, and combinations thereof.

14. The method of claim 11, wherein the historical processing data includes at least one of source location details, source environmental and processing conditions, processing facility details, processing environmental and processing conditions, distribution details, distribution environment and processing conditions, object characteristics, commercial and regulatory compliance details, and combinations thereof.

15. The method of claim 11, wherein the method further comprises storing at least a portion of the selected content in memory.

16. The method of claim 15, wherein the method further comprises storing at least a portion of the selected content is stored in a cloud-based component, wherein at least a portion of the selected content is stored in relation to the source data associated therewith.

17. The method of claim 16, wherein the method further comprises receiving a request from an associated user to retrieve selected content and the source data associated therewith stored in the memory, and retrieving the requested content.

18. The method of claim 17, wherein the requested content is retrieved based on at least one of freshness information, traceability data, historical processing data, and combinations thereof associated with the content.

19. An apparatus for marking food products with selected content at a marking station, the apparatus comprising:
at least one processor operable to control marking of the food products;
at least one marking unit operatively coupled to the at least one processor and controlled in part by the at least one processor, the at least one marking unit positioned adjacent at least one path along which the food products are conveyed, the at least one marking unit operable to mark the food products as the food products pass through the marking station; and
a non-transient memory operatively coupled to the at least one processor and operable to store data associated with the marking of the food products;
at least one input/output interface operatively coupled to the processor;
wherein the least one processor is operable to:
obtain source data associated with at least one of at least one characteristic of the food products to be marked, at least one parameter associated with the origin of the food products to be marked, at least one operational parameter of the processing system, at least one operational parameter of the at least one marking system, and combinations thereof;
obtain content marking parameters comprising at least one of content to be marked thereon, at least one rendering parameter associated with marking of the content thereon, at least one characteristic of the food products to be marked, and combinations thereof;
render the selected content in accordance with at least a portion of the content marking parameters, wherein the selected content includes at least a portion of the source data; and
mark the food products with the selected content by the at least one marking unit in accordance with at least a portion of the content marking parameters.

20. The apparatus of claim 19, wherein the food products are eggs.
